(19) United States
(12) Patent Application Publication
(10) Pub. No.: US 2006/0262231 A1
(43) Pub. Date: Nov. 23, 2006

(54) Television remote control system

(76) Inventor: Chia-Jung Chang, Hsinchu City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/133,355

(22) Filed: May 20, 2005

(51) Int. Cl. H04N 5/44

(52) U.S. Cl. 348/734

(57) ABSTRACT

A television remote control system is used to locate its remote controller quickly and conveniently. An IR transmitter and an IR receiver are both installed in a TV terminal and its remote controller terminal. When a user wants to find a remote controller by means of the TV terminal, the IR transmitter of the TV terminal transmits a signal. When the IR receiver of the remote controller receives the signal, a sound alarm device of the remote controller is driven to make sounds so that a TV viewer can easily find the remote controller.

### BACKGROUND

1. Field of Invention

The present invention relates to a television remote control system. More particularly, the present invention relates to a television remote control system having a function to locate a remote controller thereof.

2. Description of Related Art

A television (hereafter TV) is the most important apparatus for receiving information in every modern family. A modern TV of any class, size or brand always has a remote controller. A TV viewer uses the remote controller to control functions, such as program channel, sound volume, display quality and language. If the remote controller is missing, the user needs to run back and forth between a sofa and a TV in order to control the TV. Watching TV becomes quite a tiring and inconvenient entertainment.

In addition, some TVs are controlled only by their remote controllers, and viewers cannot operate them directly.

Searching for a missing TV remote controller is a troublesome task that every TV viewer has encountered. One person may find a controller immediately while another one may overturn an entire living room without finding anything. If a viewer's favorite TV program is about to start and the TV remote controller cannot be found immediately to choose the desired channel, the viewer might quickly lose his temper. However, no practical solution is known.

For the foregoing reasons, there is a need for manufacturers to provide a convenient solution in order to locate a lost TV remote controller.

### SUMMARY

It is therefore an objective of the present invention to provide a television remote control system with a function to locate a remote controller thereof.

In accordance with the foregoing and other objectives of the present invention, a television remote control system is used to locate its remote controller quickly and conveniently. An IR transmitter and an IR receiver are both installed in a TV terminal and its remote controller terminal. When a user wants to find a remote controller by means of the TV terminal, the IR transmitter of the TV terminal transmits a signal. When the IR receiver of the remote controller receives the signal, a sound alarm device of the remote controller is driven to make sounds so that a TV viewer can easily find the remote controller.

Thus, a TV viewer can locate a missing remote controller by means of a TV, equipped with an IR transmitter. The missing remote controller, equipped with an IR receiver, can receive a signal from the IR transmitter and make sounds to draw the TV viewer's attention.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 illustrates a block diagram of a television remote control system according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to let a TV viewer easily find a missing TV remote controller, the present invention provides a television remote control system having a locating function for its remote controller. An infrared transmitter (hereafter IR transmitter) and an infrared receiver (hereafter IR receiver) are both installed in a TV terminal and its remote controller terminal so that the TV terminal can be used to transmit a signal on demand; and the remote controller terminal, which receives the signal, make sounds to draw a TV viewer's attention.

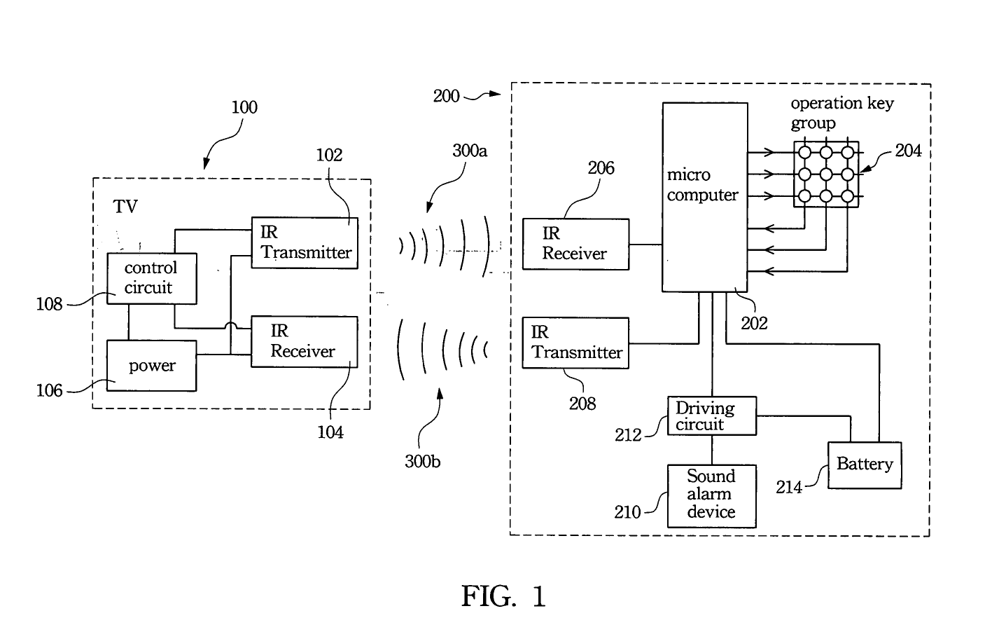

FIG. 1 illustrates a block diagram of a television remote control system according to one preferred embodiment of this invention. The television remote control system can be divided into two parts: a TV 100 and a remote controller 200.

A remote controller 200 is commonly used to control a TV 100. A TV viewer can input a demand into the remote controller 200 by means of its operation key group 204. An IR transmitter 208 is used to transmit an infrared signal (hereafter IR signal) 300b. When the TV viewer operates the operation key group 204 of the remote controller 200 to choose a desired channel, a microcomputer 202, which receives inputs from the operation key group 204, orders the IR transmitter 208 to transmit an infrared signal 300b. After an IR receiver 104 of the TV 100 receives the IR signal 300b, a control circuit 108 conducts a channel-choosing task.

If the remote controller 200 is missing, a user may locate the missing remote controller 200 by means of the TV 100. By inputting a request, such as done by pushing a button, into the TV 100, the control circuit 108 receives the request and orders the IR transmitter 102 to transmit a locating signal 300a. When an IR receiver of the remote controller 200 receives the locating signal 300a, a microcomputer 202 receives an input and orders a driving circuit 212 to drive a sound alarm device 210. The sound alarm device 210 then makes sounds to draw the TV viewer's attention so that the TV viewer can find the remote controller 200 easily.

According to above preferred embodiment, a TV viewer can locate a missing remote controller by means of a TV, equipped with an IR transmitter. The missing remote controller, equipped with an IR receiver, can receive a locating signal from the IR transmitter and make sounds to draw the TV viewer's attention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A television remote control system, having a locating function for a remote controller thereof, said television remote control system comprising:
a television, including a first infrared transmitter;
a control circuit, embedded in said television to control said first infrared transmitter to transmit a first signal; and
a remote controller, comprising:
a sound alarm device;
a driving circuit, driving said sound alarm device to make sounds;
a first infrared receiver, receiving said first signal and generating a second signal; and
a microcomputer, receiving said second signal to control said driving circuit so that said sound alarm device, driven by said driving circuit, makes sounds to draw a television viewer's attention.

2. The television remote control system of claim 1, wherein said remote controller further comprises a second infrared transmitter to transmit signals for controlling said television.

3. The television remote control system of claim 2, wherein said television further comprises a second infrared receiver to receive signals from said second infrared transmitter.
